(19) United States
(12) Patent Application Publication
(10) Pub. No.: US 2010/0140088 A1
(43) Pub. Date: Jun. 10, 2010

(54) REFERENCE ELECTRODE HAVING SELF-CALIBRATION FUNCTION AND APPARATUS FOR AUTOMATICALLY CORRECTING ELECTROCHEMICAL POTENTIAL CORRECTION APPARATUS USING THE SAME

(76) Inventors: Jei-Won YEON, Daejeon (KR); In-Kyu Choi, Daejeon (KR); Won-Ho Kim, Daejeon (KR); Kyuseok Song, Daejeon (KR)

Correspondence Address: LUCAS & MERCANTI, LLP, 475 PARK AVENUE SOUTH, 15TH FLOOR, NEW YORK, NY, 10016, US

(21) Appl. No.: 12/330,187

(22) Filed: Dec. 8, 2008

(51) Int. Cl. G01N 27/416; G01N 27/30; G01N 27/26

(52) U.S. Cl. 204/406; 204/282; 204/412; 204/415; 204/407

(57) ABSTRACT

Disclosed herein is a reference electrode having a self-calibration function, which is used in electrochemical measurement and whose measurement accuracy can be maintained for a long period of time. Also disclosed is an apparatus for automatically correcting electrochemical potential using the reference electrode. The apparatus comprises: a reference electrode, comprising an external electrode body having an electrolyte membrane at one end thereof and an electrolyte solution filled therein, and at least two electrically isolated internal electrodes which are disposed in the external electrode body in such a manner that they are immersed in the electrolyte solution; and a reference potential calibrator for applying AC voltage to the internal electrodes to measure the electrical conductivity of the electrolyte solution of the electrolyte solution and output a correction signal about the change in the reference potential of the reference electrode. The reference electrode and the apparatus can suitably calibrate the change in the potential of the reference electrode by measuring the internal electrolyte of the reference electrode and calculating the concentration of the internal electrolyte, and thus the function of the reference electrode can be maintained for a long period of time.

### BACKGROUND OF THE INVENTION

1. Field of the Invention

The present invention relates to a reference electrode and an apparatus for automatically correcting electrochemical potential using the same, and more particularly to a reference electrode having a self-calibration function which is used to measure chemical and electrochemical reactions, and an apparatus for automatically correcting electrochemical potential using the same.

2. Description of the Prior Art

To measure and control chemical and electrochemical reactions occurring in liquid phase media, such as aqueous solutions, organic solutions and high-temperature molten salts, electrochemical methods have been widely used since the late 19^{th} century. Particularly, since the end of the 19^{th} century, research and development in the fields of secondary lithium batteries, fuel cells and solar cells has been actively conducted, and thus the demand for electrochemical methods has rapidly increased.

In the electrochemical methods, the use of a reference electrode is necessary in order to accurately measure and control the potential of a working electrode. Generally, the reference electrode is fabricated based on oxidation-reduction reactions occurring in a narrow potential range.

So far, typical electrode reactions carried out using the reference electrode include the following reactions (Bard, A. J. & L. R. Faulkner, Electrochemical Methods: Fundamentals and Applications. New York: John Wiley & Sons, 2nd Edition, 2000):

2H⁺+2e⁻⇄H₂(Pt); standard hydrogen electrode (SHE) (E=0.000V);

AgCl+e⇄Ag+Cl⁻; silver-silver chloride electrode (E=0.225V saturated);

Hg₂²⁺+2e⇄2Hg,Hg₂²⁺+2Cl⁻⇄Hg₂Cl₂; saturated calomel electrode (SCE) (E=+0.242V saturated); and

Cu²⁺+2e⇄Cu; copper-copper(II) sulfate electrode (E=−0.318V).

The reaction between hydrogen ion and hydrogen gas, which is the first reaction among the above-described electrode reactions, is a reference reaction (E=0.0 V), but is not substantially used in actual circumstances, because hydrogen gas must be handled.

FIG. 1 is a schematic diagram showing the structure of a general reference electrode used in the prior art.

Referring to FIG. 1, in the prior reference electrode, an internal electrode 20 is formed in an external electrode body 11 having an electrode membrane formed at one end thereof, and an electrolyte is filled in the external electrode body in such a manner that the internal electrode 20 is partially immersed.

In a reference electrode which is most frequently used in the research or industrial field, the internal electrode 20 is generally a silver/silver chloride electrode or a calomel electrode. In a reaction employing this electrode, the concentration of chlorine ion (Cl⁻) in the electrode must be maintained constantly during measurement, because the electrode uses the fact that the activity of chlorine ion in the electrolyte 30 is constant.

In Korean Patent Registration No. 10-0477448-0000 (Mar. 9, 2005), a microvalve for nano-flow control is provided in an electrode system using a shape memory alloy in order to minimize the consumption of KCl (Cl⁻). Furthermore, in Korean Patent Registration Nos. 10-0329393-0000 (Mar. 7, 2002) and 10-0483628-0000 (Apr. 7, 2005), the leakage of the internal electrode solution KCl is suppressed using a polymer material, thus improving the electrode durability. In Korean Patent Registration No. 10-0612270-0000 (Aug. 7, 2006), a polymer electrolyte is provided to maintain the concentration of KCl constant, and an electrode system is constructed such that it can be used in an aqueous solution environment at high temperature and high pressure.

In U.S. Pat. No. 4,822,456 (Apr. 18, 1989), a permeable junction is disposed in a reference electrode to prevent the contamination of the electrode, electrodes are disposed inside and outside the junction, and an apparatus of measuring the change in potential between the inner and outer electrodes is provided.

In addition, PCT International Patent Publication Nos. WO 89/07758 (Aug. 24, 1989) and PCT/US89/00628 (Feb. 15, 1989) and Korean Patent Registration Nos. 10-0152426-0000 (Jun. 26, 1998), 10-0411715-0000 (Dec. 5, 2003) and 10-0439645-0000 (Jun. 30, 2004) disclose technologies for electrode miniaturization, which were developed using thin film processing technologies, such that reference electrodes could be applied to the semiconductor field.

As described above, with respect to the technical improvement in the reference electrode field, novel materials have been applied in the fabrication of electrodes in order to suppress the leakage of internal electrode solutions, electrodes have been improved so as to be suitable to specific environments in which they are used, and the development of technologies for electrode miniaturization has been in progress. However, there has been no attempt to develop a method of correcting the potential of a reference electrode by sensing the concentration of an electrolyte which directly influences the reaction of the reference electrode.

### SUMMARY OF THE INVENTION

The present invention has been made in order to solve the above-described problems occurring in the prior art, and it is an object of the present invention to provide a reference electrode having a self-calibration function, the measurement accuracy of which is maintained for a long period of time by continuously sensing the change in the concentration of the internal solution of the electrode with an electrical conductivity meter during the use of the reference electrode, and to provide an apparatus for automatically correcting electrochemical potential using the reference electrode.

To achieve the above object, according to a first feature of the present invention, there is provided a reference electrode having a self-calibration function, which includes: an external electrode body, which has an electrolyte membrane formed at one end thereof and an electrolyte solution filled therein; and two or more electrically isolated internal electrodes, which are disposed in the external electrode body in such a manner that they are immersed in the electrolyte solution.

According to a second feature of the present invention, there is provided a reference electrode having a self-calibration function, which includes: an external electrode body which has an electrolyte membrane formed at one end thereof and an electrolyte solution filled therein; at least one internal electrode which is disposed in the external electrode body in such a manner that it is immersed in the electrolyte solution; and at least one electrical conductivity measuring cell for measuring the electrical conductivity of the electrolyte solution, the electrical conductivity measuring cell being disposed in the external electrode body in such a manner that it is immersed in the electrolyte solution.

According to another aspect of the present invention, there is provided an apparatus for automatically correcting electrochemical potential using the reference electrode having a self-calibration function according to the first feature of the present invention, the apparatus including: a reference electrode, comprising an external electrode body having an electrolyte membrane at one end thereof and an electrolyte solution filled therein, and at least two electrically isolated internal electrodes which are disposed in the external electrode body in such a manner that they are immersed in the electrolyte solution; and a reference potential calibrator for applying AC voltage to the internal electrodes to measure the electrical conductivity of the electrolyte solution and output a correction signal about the change in the reference potential of the reference electrode.

According to still another aspect of the present invention, there is provided an apparatus for automatically correcting electrochemical potential using the reference electrode having a self-calibration function according to the second feature of the present invention, the apparatus including: a reference electrode, comprising an external electrode body having an electrolyte membrane formed at one end thereof and an electrolyte solution filled therein, at least one internal electrode which is disposed in the external electrode body in such a manner that it is immersed in the electrolyte solution, and an electrical conductivity measuring cell for measuring the electrical conductivity of the electrolyte solution, the cell being disposed in the external electrode body in such a manner that it is immersed in the electrolyte solution; and a reference potential calibrator of outputting a correction signal about the change in the reference potential of the reference electrode according to the electrical conductivity measured by the electrical conductivity measuring cell.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic diagram showing the structure of a general reference electrode used in the prior art;

FIG. 2 shows a first embodiment of a reference electrode having a self-calibration function according to the present invention;

FIG. 3 shows a second embodiment of a reference electrode having a self-calibration function according to the present invention;

FIGS. 4 to 6 show embodiments in which an apparatus of automatically correcting electrochemical potential according to the present invention is connected to an indicator electrode and an electrochemical measurement system;

FIG. 7 is a graphic diagram showing the change in electrical conductivity according to the concentration of KCl at room temperature; and

FIG. 8 is a graphic diagram showing the change in electrical conductivity according to a change in temperature of aqueous solutions having various concentrations of KCl.

### DETAILED DESCRIPTION OF THE INVENTION

Hereinafter, specific details and embodiments of the present invention will be described in detail with reference to the accompanying drawings.

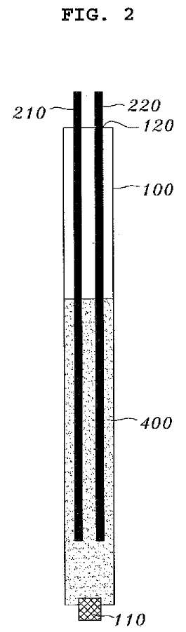

FIG. 2 shows a first embodiment of a reference electrode having a self-calibration function according to the present invention.

Referring to FIG. 2, the first embodiment of the reference electrode having a self-calibration function according to the present invention comprises an external electrode body 100, at least two electrodes 210 and 220 disposed in the electrode housing 100, and an electrolyte solution 400 filled the external electrode body.

FIG. 2 shows the case in which the number of the internal electrodes is two.

At the end of the electrode body 100, the electrolyte membrane 110 is formed in order to prevent the electrolyte solution 400 from being mixed with a solution outside the reference solution.

At the opposite end of the electrode body 100, a fixation element 120 in which the internal electrodes are inserted and fixed is formed. To the fixation element 120, the two internal electrodes are fixed so as to be spaced from each other at a given distance.

The number of the internal electrodes may be two or more.

The two or more internal electrodes are electrically isolated from each other, if the electrolyte solution 400 does not exist.

The internal electrodes 210 and 220 are formed of a material containing at least one selected from the group consisting of a metal, a conductive nonmetal, a metal chloride, a metal oxide and a metal sulfide.

Herein, the metal and conductive nonmetal material contain at least one selected from the group consisting of silver (Ag), mercury (Hg), copper (Cu), platinum (Pt), gold (Au), nickel (Ni), titanium (Ti), zirconium (Zr), molybdenum (Mo), tungsten (W), glassy carbon, and graphite.

The internal electrodes are preferably made of a material containing at least one selected from the group consisting of silver (Ag), mercury (Hg), copper (Cu), platinum (Pt), gold (Au), titanium (Ti), zirconium (Zr), and glassy carbon, and more preferably of a metal material selected from the group consisting of silver (Ag), mercury (Hg) and platinum (Pt).

The internal electrodes have at least one shape selected from the group consisting of rod, wire, tube, mesh, plate, thin layer and fiber shapes. The internal electrodes preferably have at least one shape selected from the group consisting of rod, wire, tube and thin layer shapes.

The distance between the two or more electrically isolated internal electrodes is in the range of 0.01˜200 mm, preferably 0.1˜50 mm, and more preferably 0.2˜10 mm.

If the distance between the electrically isolated internal electrodes is out of the above-specified range, the size of the reference electrode is not suitable for use in measurement, measurement errors frequently occur, and the reference electrode is difficult to miniaturize.

Also, if the distance between the internal electrodes is too short, the internal electrodes can be electrically connected with each other to form short circuits, and if the distance between the internal electrodes is too far, a drop in voltage can occur due to other unexpected reactions, such that the error in the measurement of electrical conductivity can frequently occur.

The electrolyte solution 400 is a medium that generates the reference electrode reaction.

The concentration of the electrolyte solution 400 ranges from 10⁻⁶ M to saturation concentration, preferably from 10⁻⁵ M to saturation concentration, and more preferably from 10⁻⁴ M to 1M.

If the concentration of the electrolyte solution 400 is out of the above-specified range, the error in the measurement of electrical conductivity becomes greater, and thus the accuracy of calculating the concentration of the electrolyte (for example, KCl) from electrical conductivity is reduced. Specifically, the potential value (voltage value) is proportional to the log value of activity (concentration) of the electrolyte, and thus if the concentration of the electrolyte is too low, the possibility of error occurrence is high, and if it is too high, a great difference in concentration from a measurement environment occurs, such that the decrease in electrolyte concentration caused by diffusion frequently occurs.

The electrolyte contains at least one of chloride, sulfide and bromide, and preferably contains at least one of potassium chloride (KCl) and sodium chloride (NaCl).

The geometric factor (distance between electrodes/electrode area) of the reference electrode including the internal electrodes is in the range of 10⁻⁸˜10⁸ m⁻¹, and preferably 10⁻⁶˜10⁶ m⁻¹.

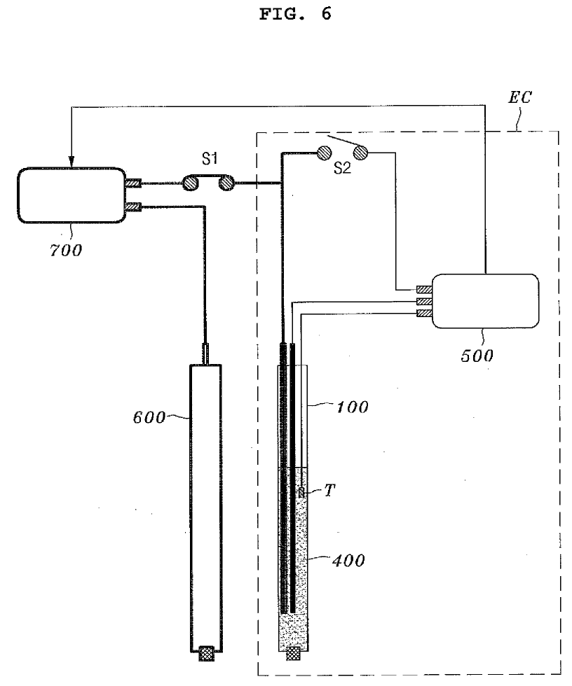

The reference electrode may further comprise a temperature sensor (T in FIG. 6) for measuring the temperature of the electrolyte solution 400. Because the temperature of the electrolyte solution is substantially the same as the temperature of a solution in which the reference electrode is placed, the temperature sensor may also be provided separately outside the reference electrode.

In the reference electrode having a self-calibration function, constructed as described above, the electrical conductivity of the electrolyte solution 400 can be measured by applying voltage to the two internal electrodes 210 and 220, and how the reference potential of the reference electrode changes can be calculated from the measured electrical conductivity and the temperature of the electrolyte solution. Using the calculated value, the measurement of a more accurate potential between the reference electrode and an indicator electrode is possible. A more detailed description will be given later.

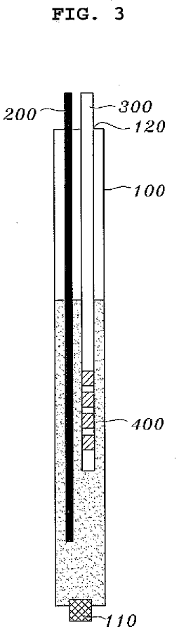

FIG. 3 shows a second embodiment of a reference electrode having a self-calibration function according to the present invention.

Referring to FIG. 3, a second embodiment of a reference electrode having a self-calibration function according to the present invention comprises an external electrode body 100, at least one internal electrode 200 disposed in the external electrode body, an electrolyte solution 400 filled in the external electrode body, and an electrical conductivity measuring cell for measuring the electrical conductivity of the electrolyte solution.

The external electrode body 100, the internal electrode 200 and the electrolyte solution 400 are substantially the same as those in the first embodiments, and thus the description thereof will be omitted herein.

The electrical conductivity measuring cell 300 is disposed in the external electrode body 100 in such a manner that it is immersed in the electrolyte solution 400.

The electrical conductivity measuring cell 300 may consist of, for example, a four-probe conductivity cell having 4 electrodes, and can measure the electrical conductivity of the electrolyte solution by a direct current measurement method.

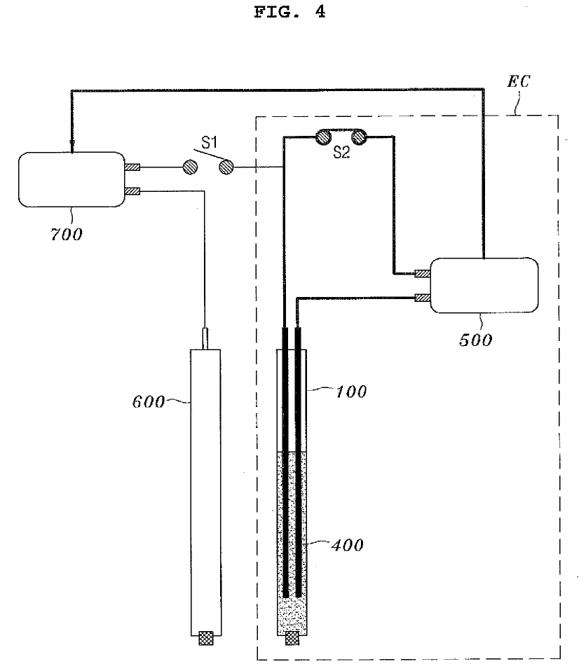

FIGS. 4 to 6 show a first embodiment of an apparatus of automatically correcting electrochemical potential using the reference electrode having a self-calibration function according to the present invention.

In a general theory, a reference electrode that is generally used in the general research and industrial field is a silver/silver chloride electrode or a calomel electrode. The reference potential of such a reference electrode changes depending on the concentration of the internal electrolyte KCl of the electrode. For example, in a silver/silver chloride electrode reaction, as can be seen in the following reaction equation and Nernst equation, the silver/silver chloride reference electrode is determined by chemical activity (a_{Cl}) that is the effective concentration of chloride ion in the internal electrolyte of the electrode.

AgCl+e [symbol] Ag⁺+Cl⁻; E°=0.222 V_{SHE}

E_{Ag/AgCl}=E°_{Ag/AgCl}−0.059 log(a_{Cl})

wherein E is the reference potential of the reference electrode, which considers the influence of chlorine ions, and E° is the standard potential of the reference electrode.

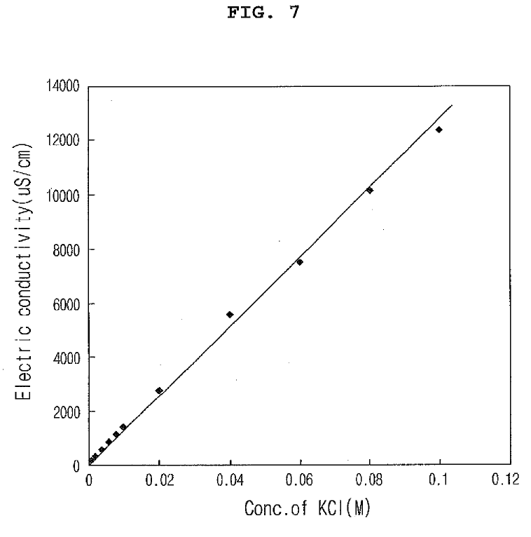

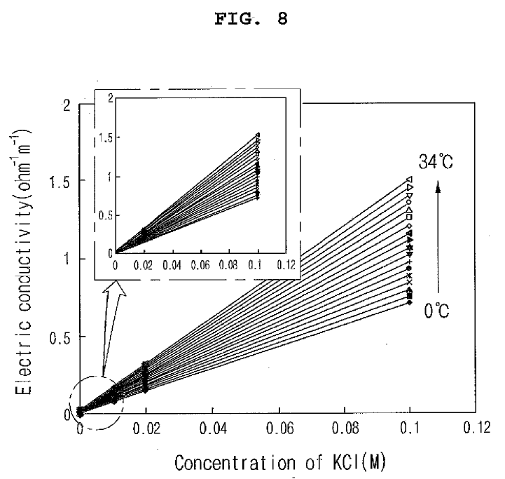

In addition, as shown in FIG. 7, the electrical conductivity of potassium chloride (KCl) that is used as an electrolyte in electrodes has a proportional relationship with the concentration of potassium chloride at room temperature. Also, as shown in FIG. 8, this proportional relationship is continually maintained in the same temperature conditions, even though the temperature is changed.

Accordingly, if the temperature and electrical conductivity of the electrolyte in the reference electrode can be seen, the concentration of the electrolyte can be easily calculated, and a potential reference indicated by the reference electrode can be predicted.

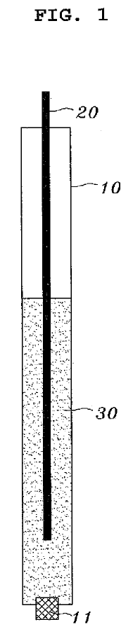

Details associated with the reference electrode are substantially the same those in the first embodiment of the reference electrode described above with reference to FIG. 1, and thus the description thereof will be omitted herein.

The reference electrode refers to an electrode serving as a reference when measuring or applying voltage for electrochemical measurement, and the indicator electrode refers to a collection of electrodes functioning as sensors. For example, when pH is measured, the indicator electrode is a pH electrode, and when ions are sensed, the indicator electrode is an ion-sensing electrode.

Generally, when the voltage of an indicator electrode 600 is measured to be 1V, the measured voltage means 1 V relative to the reference electrode (0 V). Accordingly, the indicator electrode 600 is changed depending on an object to be measured, but the reference electrode is not changed.

In FIGS. 4 to 6, the portion (EC) indicated by the dotted line is the apparatus for automatically correcting the reference electrode having a self-calibration function according to the present invention.

FIGS. 4 to 6 shows that the apparatus is connected with the indicator electrode 600 and an electrostatic potential/current meter 700

Referring to FIGS. 4 to 6, the first embodiment of the apparatus for automatically correcting the reference electrode having self-calibration function according to the present invention comprises: a reference electrode, comprising an external electrode body 100 having an electrolyte membrane at one end thereof and an electrolyte solution 400 filled therein, and at least two electrically isolated internal electrodes which are disposed in the external electrode body 100 in such a manner that they are immersed in the electrolyte solution; and a reference potential calibrator 500 of applying AC voltage to the internal electrodes to measure the electrical conductivity of the electrolyte solution of the electrolyte solution and output a correction signal about the change in the reference potential of the reference electrode.

The reference potential calibrator 500 applies voltage to the two internal electrodes to measure the electrical conductivity of the electrolyte solution, calculates the resulting concentration of the electrolyte solution, and outputs an information signal for a correction value for correcting the reference potential.

Herein, the reference potential calibrator 500 may be constructed such that it measures only electrical conductivity and outputs information therefor, such that the concentration of the electrolyte can be calculated in the electrostatic potential/current meter 700, and the reference potential can be calibrated based on the calculated electrolyte concentration.

Also, the reference potential calibrator 500 can measure the electrical conductivity of the electrolyte using an AC or DC measurement method.

In the DC measurement method, the range of frequency that is used in the measurement of electrical conductivity is, for example, between 0.1 Hz and 1000 KHz, preferably 0.1 Hz and 100 KHz, and more preferably 0.1 Hz and 10 KHz.

If the DC frequency in the measurement of electrical conductivity is out of the above-specified range, a great error in the measurement of electrical conductivity occurs, thus making the accurate calibration of the reference electrode difficult. If the measurement frequency is too high, a capacitor component at the electrode/electrolyte interface is reflected in the measured value of the electrical conductivity, and it is too low, the resistance of a film produced on the surface of the electrodes causes an error in the measured value of the electrical conductivity of the electrolyte.

In the DC measurement method, the intensity of current is preferably less than 10⁻¹ A cm⁻².

If the current intensity is out of the above-specified values, the size of the electrical conductivity measuring cell and the power capacity of the measurement system can increase, such that the system cannot be optimized, and it can make it difficult to accurately measure the electrical conductivity of the electrolyte.

If the temperature of the electrolyte is required for more accurate calculation, as shown in FIG. 6, a temperature sensor T for measuring the temperature of the electrolyte can further be provided in the reference electrode.

FIG. 4 shows a relay connection state in the calibration of the reference electrode.

If the potential of the reference electrode is to be calibrated, a switch S1 is turned off, and a switch S2 is turned on, such that the reference potential calibrator 500 measures the electrical conductivity of the electrolyte solution 400 using the internal electrodes of the reference electrode. The measured electrical conductivity or a correction signal considering the electrical conductivity is transmitted to the electrostatic potential/current meter 700 that is an external device.

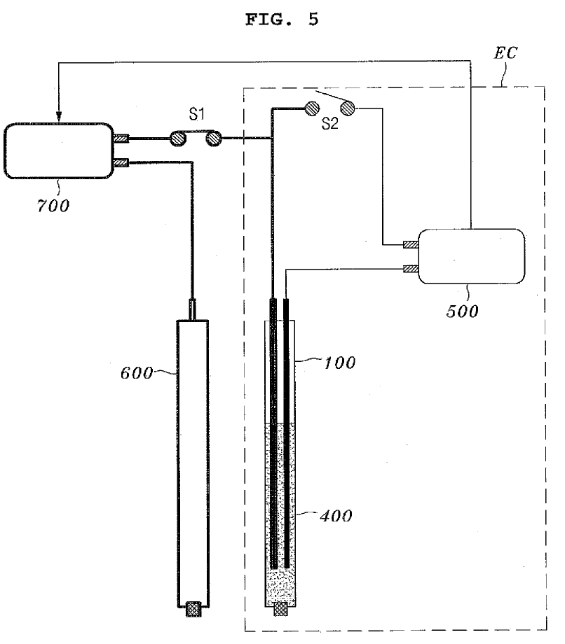

FIG. 5 shows a relay connection state in measurement with an electrochemical device.

If the reference electrode is not calibrated, that is, if measurement is performed with a general electrochemical device, for example the electrostatic potential/current meter 700, the switch S1 is turned on, and the switch S2 is turned off.

One of the internal electrodes of the reference electrode and the indicator electrode 600 are connected to the electrostatic potential/current meter 700, and the apparatus is operated in a general manner.

Accordingly, before or after general measurement as shown in FIG. 5 is performed, connection as shown in FIG. 4 is made, the degree of the change in the concentration of the electrolyte solution in the reference electrode is determined, and final potential/current values are determined in consideration of the determined concentration change.

A second embodiment of the apparatus for automatically correcting electrochemical potential using the reference electrode having a self-calibration function according to the present invention comprises: a reference electrode, comprising an external electrode body having an electrolyte membrane formed at one end thereof and an electrolyte solution filled therein, at least one internal electrode which is disposed in the external electrode body in such a manner that it is immersed in the electrolyte solution, and an electrical conductivity measuring cell for measuring the electrical conductivity of the electrolyte solution, the cell being disposed in the external electrode body in such a manner that it is immersed in the electrolyte solution; and a reference potential calibrator of outputting a correction signal about the change in the reference potential of the reference electrode according to the electrical conductivity measured by the electrical conductivity measuring cells.

Namely, the second embodiment of the apparatus for automatically correcting electrochemical potential using the reference electrode having a self-calibration function according to the present invention differs from the first embodiment in that the reference electrode shown in FIG. 3 is used. The remaining elements are substantially the same as those in the first embodiment, and thus the description thereof will be omitted herein.

FIG. 7 is a graphic diagram showing the change in electrical conductivity according to concentration of KCl at room temperature, and FIG. 8 is a graphic diagram showing the change in electrical conductivity according to change in temperature of aqueous solutions having various KCl concentrations.

The present invention will now be described in detail by way of example of the case in which potassium chloride (KCl) is used as an electrolyte.

FIG. 7 shows the change in the electrical conductivity of potassium chloride (KCl) that is frequently used as an electrolyte in a reference electrode, when potassium chloride was diluted in distilled water. When 0.1 M KCl is used as the internal electrolyte of the reference electrode that is used in the cooling water of a heat-exchanger for a long period of time, the change in the concentration of the electrolyte can be predicted by measuring the electrical conductivity of the electrolyte using the inventive reference electrode and the inventive apparatus for automatically correcting electrochemical potential, even though the concentration of the internal electrolyte is decreased. Accordingly, the change in the potential of the reference electrode can be sensed.

Namely, the measured electrical conductivity is linearly proportional to KCl concentration, and AC voltage is generally applied for the measurement of the electrical conductivity. When the electrical conductivity is seen, KCl concentration can be determined (KCl concentration □ a_{Cl}), and the accurate reference potential E_{Ag/AgCl} of the reference electrode can be calculated using the above equation 1.

As described above, the reference electrode having a self-calibration function according to the present invention and the apparatus for automatically correcting electrochemical potential using the same can calculate the concentration of the internal electrolyte (such as chlorine ion) of the reference electrode by measuring the electrical conductivity of the electrolyte, and thus can suitably calibrate the change in the potential of the reference electrode, even when the reference electrode is exposed to an experimental environment for a long period of time, such that the concentration of the electrolyte solution in the electrode changes. Accordingly, the function of the reference electrode can be maintained for a long period of time.

While the reference electrode having a self-calibration function and the apparatus for automatically correcting electrochemical potential using the same have been described with reference to the accompanying drawings, the scope of the present invention is not limited to the embodiments disclosed herein and the drawings and can be modified within the range in which the technical idea of the present invention is protected.

What is claimed is:

1. A reference electrode having a self-calibration function, which comprises:
an external electrode body, which has an electrolyte membrane formed at one end thereof and an electrolyte solution filled therein; and
two or more electrically isolated internal electrodes, which are disposed in the external electrode body in such a manner that they are immersed in the electrolyte solution.

2. The reference electrode of claim 1, which further comprises a temperature sensor for measuring the temperature of the electrolyte.

3. The reference electrode of claim 1, wherein the internal electrodes are formed of a material containing at least one selected from the group consisting of a metal, a conductive nonmetal, a metal chloride, a metal oxide and a metal sulfide.

4. The reference electrode of claim 1, wherein the internal electrodes have at least one shape selected from the group consisting of rod, wire, tube, mesh, plate, thin layer and fiber shapes.

5. The reference electrode of claim 1, wherein the number of the internal electrodes is 2 to 5.

6. The reference electrode of claim 1, wherein a distance between the internal electrodes is 0.01200 mm.

7. The reference electrode of claim 1, wherein the concentration Of the electrolyte solution ranges from 10⁻⁶ M to saturation concentration.

8. A reference electrode having a self-calibration function, which comprises:
an external electrode body which has an electrolyte membrane formed at one end thereof and an electrolyte solution filled therein;
at least one internal electrode which is disposed in the external electrode body in such a manner that it is immersed in the electrolyte solution; and
at least one electrical conductivity measuring cell for measuring electrical conductivity of the electrolyte solution, the electrical conductivity measuring cell being disposed in the external electrode body in such a manner that it is immersed in the electrolyte solution.

9. The reference electrode of claim 8, which further comprises a temperature sensor for measuring the temperature of the electrolyte.

10. The reference electrode of claim 8, wherein the internal electrodes are formed of a material containing at least one selected from the group consisting of a metal, a conductive nonmetal, a metal oxide, a metal chloride and a metal sulfide.

11. The reference electrode of claim 8, wherein the internal electrodes have at least one shape selected from the group consisting of rod, wire, tube, mesh, plate, thin layer and fiber shapes.

12. The reference electrode of claim 8, wherein the number of the internal electrodes is 2 to 5.

13. The reference electrode of claim 8, wherein a distance between the internal electrodes is 0.01200 mm.

14. The reference electrode of claim 8, wherein the concentration of the electrolyte solution ranges from 10⁻⁶ M to saturation concentration.

15. An apparatus for automatically correcting electrochemical potential using a reference electrode having a self-calibration function, the apparatus comprising:
a reference electrode, comprising an external electrode body having an electrolyte membrane at one end thereof and an electrolyte solution filled therein, and at least two electrically isolated internal electrodes which are disposed in the external electrode body in such a manner that they are immersed in the electrolyte solution; and
a reference potential calibrator for applying AC voltage to the internal electrodes to measure electrical conductivity of the electrolyte solution and output a correction signal about the change in reference potential of the reference electrode.

16. The apparatus of claim 15, wherein the internal electrodes are formed of a material containing at least one selected from the group consisting of a metal, a conductive nonmetal, a metal oxide, a metal chloride and a metal sulfide.

17. The apparatus of claim 15, wherein said metal and nonmetal materials contain at least one selected from the group consisting of silver (Ag), mercury (Hg), copper (Cu), platinum (Pt), gold (Au), nickel (Ni), titanium (Ti), zirconium (Zr), molybdenum (Mo), tungsten (W), glassy carbon and graphite.

18. The apparatus of claim 15, wherein the internal electrodes have at least one shape selected from the group consisting of rod, wire, tube, mesh, plate, thin layer and fiber shapes.

19. The apparatus of claim 15, wherein the number of the internal electrodes is 2 to 5.

20. The apparatus of claim 15, wherein a distance between the internal electrodes is 0.01200 mm.

21. The apparatus of claim 15, wherein the concentration of the electrolyte solution ranges from 10⁻⁶ M to saturation concentration.

22. The apparatus of claim 15, wherein the electrolyte contains at least one selected from the group consisting of a chloride, a sulfide and a bromide.

23. The apparatus of claim 15, wherein the electrolyte contains at least one of potassium chloride (KCl) and sodium chloride.

24. The apparatus of claim 15, wherein the geometric factor (distance between electrodes/electrode area) of the reference electrode is in a range of. 10⁻⁸˜10⁸ m⁻¹.

25. An apparatus for automatically correcting electrochemical potential using a reference electrode having a self-calibration function, the apparatus comprising:
a reference electrode, comprising an external electrode body having an electrolyte membrane formed at one end thereof and an electrolyte solution filled therein, at least one internal electrode which is disposed in the external electrode body in such a manner that it is immersed in the electrolyte solution, and an electrical conductivity measuring cell for measuring the electrical conductivity of the electrolyte solution, the cell being disposed in the external electrode body in such a manner that it is immersed in the electrolyte solution; and
a reference potential calibrator of outputting a correction signal about a change in the reference potential of the reference electrode according to the electrical conductivity measured by the electrical conductivity measuring cells.

26. The apparatus of claim 25, wherein the internal electrodes are formed of a material containing at least one selected from the group consisting of a metal, a conductive nonmetal, a metal oxide, a metal chloride and a metal sulfide.

27. The apparatus of claim 25, wherein said metal and nonmetal materials contain at least one selected from the group consisting of silver (Ag), mercury (Hg), copper (Cu), platinum (Pt), gold (Au), nickel (Ni), titanium (Ti), zirconium (Zr), molybdenum (Mo), tungsten (W), glassy carbon and graphite.

28. The apparatus of claim 25, wherein the internal electrodes have at least one shape selected from the group consisting of rod, wire, tube, mesh, plate, thin layer and fiber shapes.

29. The apparatus of claim 25, wherein the number of the internal electrodes is 2 to 5.

30. The apparatus of claim 25, wherein a distance between the internal electrodes is 0.01200 mm.

31. The apparatus of claim 25, wherein the concentration of the electrolyte solution ranges from 106 M to saturation concentration.

32. The apparatus of claim 25, wherein the electrolyte contains at least one selected from the group consisting of a chloride, a sulfide and a bromide.

33. The apparatus of claim 25, wherein the electrolyte contains at least one of potassium chloride (KCl) and sodium chloride.

34. The apparatus of claim 25, wherein the geometric factor (distance between electrodes/electrode area) of the reference electrode is in a range of 10⁻⁸˜10⁸ m⁻¹.

35. The apparatus of claim 25, wherein the intensity of current that is used in the measurement of the electrical conductivity is less than 10⁻¹ A cm⁻² for a direct current method.

36. The apparatus of claim 25, wherein the range of frequency that is used in the measurement of the electrical conductivity is between 0.1 Hz and 1000 KHz for an alternating current method.

37. The apparatus of claim 25, wherein the range of frequency that is used in the measurement of the electrical conductivity is between 0.1 Hz and 100 KHz for an alternating current method.

38. The apparatus of claim 25, wherein the range of frequency that is used in the measurement of the electrical conductivity is between 0.1 Hz and 10 KHz for an alternating current method.

39. The apparatus of claim 25, which further comprises a temperature sensor for measuring the temperature of the electrolyte.
